(19) United States
(12) Patent Application Publication
(10) Pub. No.: US 2008/0040003 A1
(43) Pub. Date: Feb. 14, 2008

(54) Safety System for Vehicle Occupants

(76) Inventors: Mario Kroeninger, Buehl (DE); Marc Theisen, Besigheim (DE); Michael Bunse, Vaihingen/Enz (DE); Maike Moldenhauer, Waldenbuch (DE); Matthias Wellhoefer, Stuttgart (DE); Volker Frese, Schwieberdingen (DE)

Correspondence Address: KENYON & KENYON LLP, ONE BROADWAY, NEW YORK, NY, 10004, US

(21) Appl. No.: 11/628,468

(22) PCT Filed: Apr. 25, 2005
(86) PCT No.: PCT/EP05/51843

§ 371 Date: Dec. 1, 2006

(30) Foreign Application Priority Data
Jun. 3, 2004 (DE) 10 2004 027 206.9

(51) Int. Cl. B60R 21/01; B60R 21/16; B60R 22/48; G01C 21/00

(52) U.S. Cl. 701/45; 280/735; 280/801.1; 701/207

(57) ABSTRACT

A safety system for vehicle occupants, having sensors for acquiring crash-relevant data such as acceleration and/or pressure values, having a control device, and having restraints, such as an air bag, safety belt, or the like. The safety system 1 has a connection to a navigation system of the vehicle. Data of the navigation system of the vehicle, such as in particular location data of the vehicle, are supplied to the safety system, and are taken into account in a triggering decision for restraint.

### FIELD OF THE INVENTION

The invention generally relates to a safety system for vehicle occupants.

### DESCRIPTION OF RELATED ART

In safety systems of the named type, the occurrence of a crash situation is detected using sensors that acquire measurement quantities such as e.g. acceleration and/or pressure. The sensors can be situated centrally in the vehicle or also in its periphery. In particular for the recognition of side crashes, externally positioned sensors are preferably used, which are for example situated in the area of the vehicle doors and which respond to the action of pressure. Vehicles are also increasingly being equipped with satellite-supported navigation systems that enable determination of the location of the vehicle. An essential problem in the controlling of a safety system of this general type, in particular when there is an angular or side collision, lies in the requirement of having to make a decision for the triggering of restraint means, such as air bags, safety belts, and the like, at a very early point in time in the crash process, while at the same time nonetheless achieving a high degree of safety against misuse. In the sense of the present invention, safety against misuse is understood as the capacity of a generic safety system to make a decision to trigger restraint means only if a corresponding risk to the occupants of the vehicle actually exists. The requirement of an early triggering decision results from the fact that in the named types of crashes the vehicle has only a comparatively short crumple zone. A high degree of safety against misuse is required in order to prevent unnecessary triggering of restraint means, because this results in expensive repairs to the safety system.

### SUMMARY OF THE INVENTION

The present invention offers the advantage that it succeeds in fulfilling the named, conflicting requirements better than has previously been possible. Here the present invention makes use of the recognition that with the aid of data from the navigation system it is possible to determine the location of the vehicle with a high degree of precision. These data are used to evaluate the probability of an angular or side crash, thus enabling an early plausibilization of a triggering decision. If, for example, the vehicle is situated in the area of an intersection, if the output signals of acceleration and/or pressure sensors assume values that indicate a danger, there is good reason to infer that the present event is a side crash. The decision for the triggering of suitable restraint means can thus be plausibilized at an early point in time. On the other hand, an unnecessary triggering of restraint means can largely be prevented with the greatest possible protective function for the vehicle occupants. If, in contrast, in a different situation the data of the navigation system do not contain any indication of an intersection or a junction with a side street, and the vehicle is moving in an orderly fashion in its lane, then the probability of a side crash is to be evaluated as comparatively low. The present invention makes it possible to carry out the plausibilization of a triggering decision in a more differentiated fashion.

In addition, statistical data relating to a particular location, concerning the frequency of accidents at that location, are particularly advantageously taken into account in the triggering decision for restraint means. In this way, the safety system can be made more sensitive at points in the street network having a high frequency of collisions.

Furthermore, current environmental data at the current location of the vehicle can be particularly advantageously acquired and taken into account in the decision for triggering restraint.

### BRIEF DESCRIPTION OF THE DRAWINGS

The invention will be described in greater detail with reference to the following drawings wherein:

FIG. 1 shows a block diagram of a safety system according to the present invention,

FIG. 2 shows another block diagram of a safety system,

FIG. 3 shows another block diagram of a safety system.

### DETAILED DESCRIPTION OF THE INVENTION

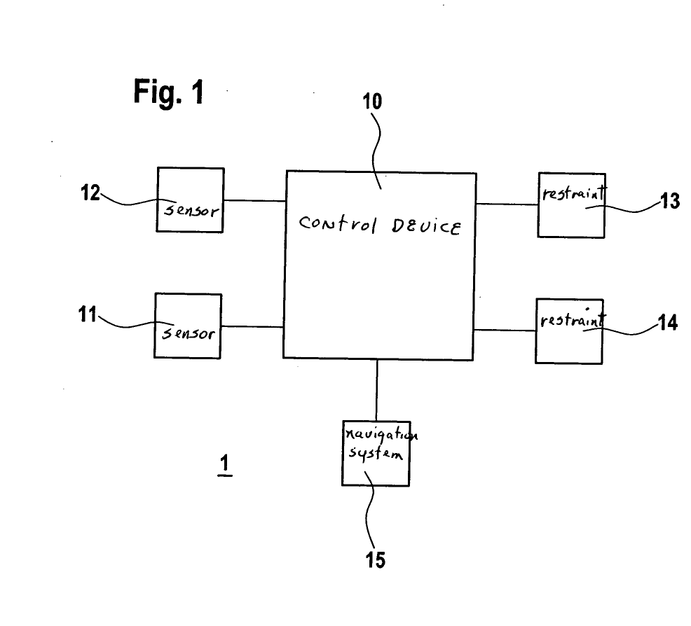

FIG. 1 shows, as an example, a block diagram of a safety system according to the present invention. Safety system 1 includes a control device 10. Sensors 11, 12 are connected to control device 10. These sensors acquire measurement quantities, such as for example acceleration and/or pressure, that can result from a crash event. Sensors 11, 12 can be situated at a centrally located point of the vehicle or at a peripheral location. Modern vehicles frequently have a centrally situated sensor that acquires acceleration, as well as what are known as externally positioned sensors situated on the periphery of the vehicle, for example in the door areas, which acquire pressure values. In addition, restraint means 13, 14, such as for example air bags and/or safety belts, are connected to control device 10. In addition, control device 10 is connected to an on-board navigation system 15.

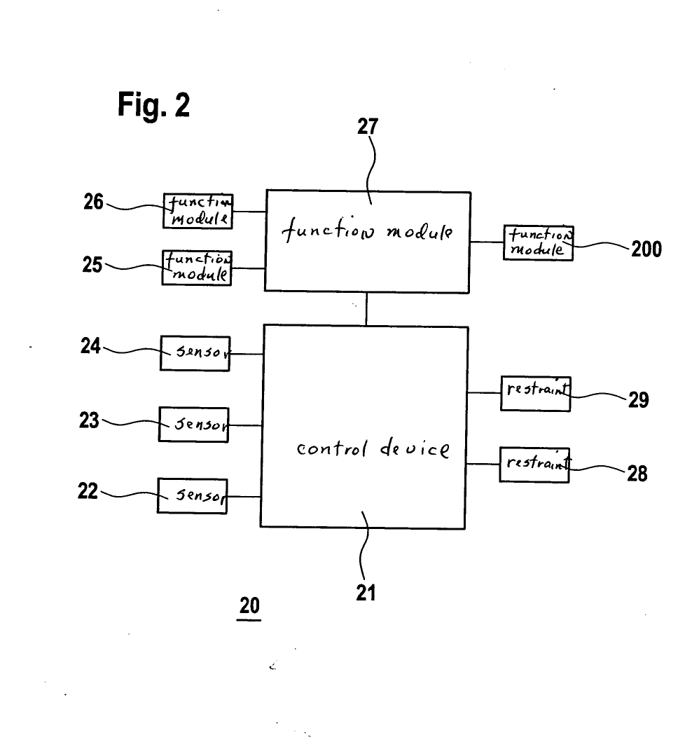

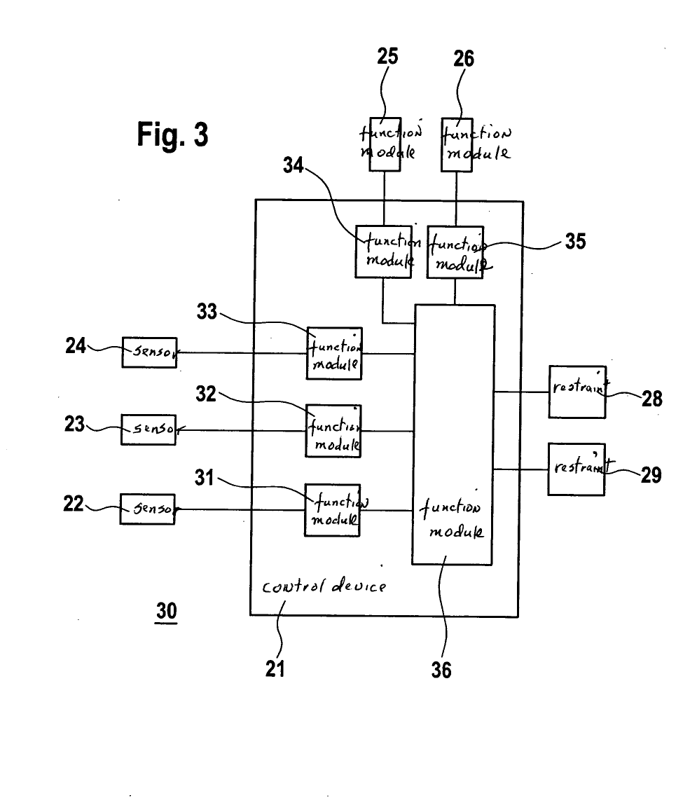

In the following, the principle of the functioning of safety system 1 shown in FIG. 1 is described. Sensors 11, 12 acquire acceleration and/or pressure values, and convert these measurement values into corresponding electrical output signals that are supplied to control device 10. Control device 10 evaluates these output signals of sensors 11, 12, and controls restraint means 13, 14 in a corresponding manner. In a crash, for example safety belts are tightened and air bags are triggered in order to protect the vehicle occupants. According to the present invention, control device 10 additionally evaluates data supplied by on-board navigation system 15 for a triggering decision. These are preferably data that relate to the current location of the vehicle, to the extent that these data may be relevant to a crash event. This is explained in more detail below on the basis of exemplary embodiments shown in FIG. 2 and FIG. 3.

FIG. 2 shows a block diagram of a safety system 20 that again has a control device 21 as a central component. Sensors 22, 23, 24 are connected to control device 21. In addition, restraint means 28, 29 are connected to control device 21. In addition, a function module 27 is connected to control device 21. Finally, function modules 25 and 26 are also connected to function module 27. In the following, the functioning of safety system 20 is described. Sensors 22, 23, 24 continuously acquire typical measurement quantities on the basis of which the presence of a critical accident situation can be inferred. Thus, sensor 22, which is for example situated centrally, acquires for example the acceleration of the vehicle in the transverse direction and in the longitudinal direction. Another sensor 23 acquires for example the acceleration in the z direction. Externally positioned sensors 24, preferably situated on the periphery of the vehicle, acquire acceleration and/or pressure in the area of the external skin of the vehicle. The output signals of named sensors 22, 23, 24 are supplied to control device 21, and are processed by this device according to predeterminable criteria in order to recognize a critical accident situation and, in the case of danger, to make a triggering decision as early as possible for restraint means 28, 29, which are provided for the protection of the vehicle occupants. According to the present invention, for this triggering decision further data are also evaluated that are prepared in function modules 25, 26, 27, 200, and are supplied to control device 21. Function module 25 acquires, for example, data relating to vehicle dynamics, such as in particular the speed of the vehicle, and supplies these data to function module 27. Function module 26 acquires data from the vehicle navigation system and supplies these data to function module 27. Of particular interest for the present invention are data relating to the current location of the vehicle, because these data can be used to make a more reliable triggering decision for restraint means 28, 29, while simultaneously improving safety against misuse. This is now explained in more detail on the basis of two exemplary driving situations. If, for example, the data supplied by function modules 25, 26 demonstrate that the vehicle is moving at a comparatively high speed on the right lane of a highway, the probability of a side crash, in particular the probability of a side crash from the right, is to be rated as low. Output signals of sensors 24 can therefore, in a manner adapted to the particular situation, be evaluated with a lower weighting, and can be disregarded entirely if warranted. In practice, this can usefully be achieved in that predeterminable threshold values for the output signals of sensors 24 are adapted, in particular raised, by the function module.

If; on the other hand, the vehicle dynamics data supplied by function module 25 and the location data already supplied by function module 26 demonstrate that the vehicle is traveling at an appropriate speed on a street network within the city, perhaps just passing through an intersection, there is a significantly greater risk of a side crash. This greater risk can usefully be taken into account by assigning a greater significance to the output signals of peripheral sensors 24. In practice, this can usefully be achieved in that function module 27 lowers predeterminable threshold values for the output signals of sensors 24, in order to increase their response sensitivity. Particularly advantageously, safety system 21 is also provided, in addition to and linked with the location data supplied by function module 26, with statistical data concerning the frequency of accidents associated with a particular location. In this way, the safety system can for example be switched to be more sensitive when approaching a location known to have a high frequency of accidents. In practice, this can again take place by lowering the threshold values for output signals of sensors 22, 23, 24.

In an advantageous variant embodiment of the present invention, in this connection another function module 200 can additionally be provided that acquires environmental data and evaluates these data. In connection with the location data supplied by function module 26, in this way a still more reliable risk evaluation can take place if necessary. If, for example, a stretch is being traveled that is evaluated as a critical location having high accident frequency with hydroplaning, on the basis of the environmental data supplied by function module 200 it can be verified whether this risk actually exists at the current point in time or not. If it is raining heavily, this risk is to be taken into account as a precaution. If the roadway is dry, on the other hand, it can be assumed that the risk is lower.

Another exemplary embodiment of the present invention is explained on the basis of safety system 30, shown in FIG. 3 as a block diagram. Here, function modules 31, 32, 33, 34, 35, connected to sensors 22, 23, 24 or to function modules 25, 26, are provided. These function modules process the output signals supplied by sensors 22, 23, 24 and by function modules 25, 26, and supply these signals to a function module 36. Function module 36 evaluates all the input signals supplied to it, and derives therefrom the triggering decision for restraint means 28, 29.

1-8. (canceled)

9. A safety system (1, 20, 30) for vehicle occupants, comprising sensors (11, 12, 22, 23, 24) for acquiring crash-relevant data, a control device (10, 21), and restraint means (28, 29), wherein the safety system (1, 20, 30) has a connection to a navigation system (15) of the vehicle, and data of the navigation system (15) of the vehicle are capable of being supplied to the safety system (1, 20, 30).

10. The safety system according to claim 9, wherein the data of the navigation system (15) of the vehicle which is capable of being supplied to the safety system (1, 20, 30) includes location data of the vehicle.

11. The safety system according to claim 9, wherein the crash relevant data is at least one of acceleration and pressure values, and wherein the restraint means includes at least one of an air bag and a safety belt.

12. The safety system according to claim 10, wherein the crash relevant data is at least one of acceleration and pressure values, and wherein the restraint means includes at least one of an air bag and a safety belt.

13. The safety system according to claim 10, wherein location data of the vehicle are used for plausibilization of a triggering decision for restraint means (28, 29) of the safety system (1, 20, 30).

14. The safety system according to claim 12, wherein location data of the vehicle are used for plausibilization of a triggering decision for restraint means (28, 29) of the safety system (1, 20, 30).

15. The safety system according to claim 10, wherein triggering threshold values of the safety system (1, 20, 30) are capable of being modified dependent on location data.

16. The safety system according to claim 13, wherein triggering threshold values of the safety system (1, 20, 30) are capable of being modified dependent on location data.

17. The safety system according to claim 13, wherein given a location-dependent change in risk, triggering threshold values are lowered or raised.

18. The safety system according to claim 13, wherein in addition to vehicle location data, vehicle dynamics data are acquired and are taken into account in the triggering decision.

19. The safety system according to claim 14, wherein in addition to vehicle location data, vehicle dynamics data are acquired and are taken into account in the triggering decision.

20. The safety system according to claim 10, wherein information concerning the likelihood or frequency of accidents of a particular location are allocated to the location data of the vehicle, and triggering decisions of the safety system (1, 20, 30) are plausibilized dependent on the likelihood or frequency of accidents at a particular location that has been reached.

21. The safety system according to claim 12, wherein information concerning the likelihood or frequency of accidents of a particular location are allocated to the location data of the vehicle, and triggering decisions of the safety system (1, 20, 30) are plausibilized dependent on the likelihood or frequency of accidents at a particular location that has been reached.

22. The safety system according to claim 13, wherein in addition to location data of the vehicle, environmental data (function module 200) at the location of the vehicle are acquired and are taken into account in the triggering decision for the restraint means (28, 29).

23. The safety system according to claim 14, wherein in addition to location data of the vehicle, environmental data (function module 200) at the location of the vehicle are acquired and are taken into account in the triggering decision for the restraint means (28, 29).

24. The safety system according to claim 15, wherein in addition to location data of the vehicle, environmental data (function module 200) at the location of the vehicle are acquired and are taken into account in the triggering decision for the restraint means (28, 29).

25. The safety system according to claim 17, wherein in addition to location data of the vehicle, environmental data (function module 200) at the location of the vehicle are acquired and are taken into account in the triggering decision for the restraint means (28, 29).

26. The safety system according to claim 18, wherein in addition to location data of the vehicle, environmental data (function module 200) at the location of the vehicle are acquired and are taken into account in the triggering decision for the restraint means (28, 29).

27. The safety system according to claim 20, wherein in addition to location data of the vehicle, environmental data (function module 200) at the location of the vehicle are acquired and are taken into account in the triggering decision for the restraint means (28, 29).

28. The safety system according to claim 22, wherein triggering threshold values are capable of being modified dependent on environmental data.
